(19) United States
(12) Patent Application Publication
(10) Pub. No.: US 2024/0227167 A9
(43) Pub. Date: Jul. 11, 2024

(54) ROBOT MOUNTING BASE

(71) Applicant: OKUMA CORPORATION, Niwa-Gun (JP)

(72) Inventor: Kazumasa UKAI, Niwa-Gun (JP)

(73) Assignee: OKUMA CORPORATION, Niwa-Gun (JP)

(21) Appl. No.: 18/487,171

(22) Filed: Oct. 16, 2023

(30) Foreign Application Priority Data
Oct. 24, 2022 (JP) 2022-170109

(51) Int. Cl. B25J 9/00

(52) U.S. Cl. CPC B25J 9/0096; B25J 9/0009

(57) ABSTRACT

A robot mounting base for an industrial robot includes a mounting base main body having a top surface on which the industrial robot is disposed. The robot mounting base allows the industrial robot to work on a machine tool in an installation state close to an outer surface of the machine tool. A cutoff portion is formed at least at one end portion in the mounting base main body in a horizontal direction along the outer surface in the installation state, and the cutoff portion positions so that a surface on the machine tool side is away from the machine tool with respect to another end portion.

### CROSS REFERENCE TO RELATED APPLICATION

This application claims the benefit of Japanese Patent Application Number 2022-170109 filed on Oct. 24, 2022, the entirety of which is incorporated by reference.

### FIELD OF THE INVENTION

The disclosure relates to a robot mounting base that movably supports an industrial robot.

### BACKGROUND OF THE INVENTION

When a workpiece is input into and output from a machine tool, an industrial robot such as an articulated robot is used in some cases.

The industrial robot is, for example, as disclosed in JP 2018-58142 A, supported on a travelable/movable cart, namely a robot mounting base, such that its position relative to a machine tool can be adjusted. Accordingly, an operator can move the industrial robot together with the cart to any position by grasping a handle disposed on the cart.

Since the above-described conventional cart has a square shape in a plan view, when it is located in a lateral posture close to a front side of a door of a machine tool, an industrial robot and the cart take up space. In view of this, when an operator operates or maintains the machine tool on the front surface side of the machine tool, it is likely that the cart interferes with the operation and makes it difficult for the operator to work.

Therefore, it is an object of the disclosure to provide a robot mounting base that does not interfere with work by an operator even when it is installed close to a machine tool.

### SUMMARY OF THE INVENTION

In order to achieve the above-described object, the disclosure provides a robot mounting base for an industrial robot. The robot mounting base includes a mounting base main body having a top surface on which the industrial robot is disposed. The robot mounting base allows the industrial robot to work on a machine tool in an installation state close to an outer surface of the machine tool. A cutoff portion is formed at least at one end portion in the mounting base main body in a horizontal direction along the outer surface in the installation state, and the cutoff portion positions so that a surface on the machine tool side is away from the machine tool with respect to another end portion.

In another aspect of the disclosure, in the above-described configuration, the cutoff portion is formed by making the surface on the machine tool side into an inclined surface that inclines in a direction away from the machine tool toward the one end portion side.

In another aspect of the disclosure, in the above-described configuration, the inclined surface is partially formed on the one end portion side, and the industrial robot is installed on a top surface of the one end portion.

In another aspect of the disclosure, in the above-described configuration, a pair of inclined surfaces are disposed so as to be symmetrical in a plan view with an installation position of the industrial robot as a center, and the one end portion has a tapered shape.

According to the disclosure, in the installation state, the cutoff portion that positions so that a surface on the machine tool side is away from the machine tool with respect to another end portion is formed at least at one end portion of the mounting base main body. Thus, a wide space including the cutoff portion is formed between the mounting base main body and the machine tool and even when the mounting base main body is installed close to the machine tool. Accordingly, work by an operator is no longer hindered.

According to another aspect of the disclosure, in addition to the above-described effect, the cutoff portion is formed by making the surface on the machine tool side into the inclined surface that inclines in the direction away from the machine tool toward the one end portion side. Accordingly, the cutoff portion can be easily formed.

According to another aspect of the disclosure, in addition to the above-described effect, the inclined surface is partially formed on the one end portion side, and the industrial robot is installed on the top surface of the one end portion. Accordingly, it is possible to ensure a wider space for the operator to work by suppressing an amount of projection of the mounting base main body to a working position of an articulated robot on the machine tool side.

According to another aspect of the disclosure, in addition to the above-described effect, a pair of inclined surfaces are disposed so as to be symmetrical in a plan view with the installation position of the industrial robot as a center, and the one end portion has a tapered shape. Accordingly, a space can be similarly formed even when the mounting base main body is installed in a reverse direction.

### BRIEF DESCRIPTION OF THE DRAWINGS

FIG. 1 is a perspective view of a robot mounting base.

FIG. 2 is a front view of the robot mounting base.

FIG. 3 is a back view of the robot mounting base.

FIG. 4 is a left side view of the robot mounting base.

FIG. 5 is a right side view of the robot mounting base.

FIG. 6 is a plan view of the robot mounting base.

FIG. 7 is a bottom view of the robot mounting base.

FIG. 8 is a cross-sectional view taken along a line A-A in FIG. 6.

FIG. 9 is a plan view illustrating a use state of the robot mounting base.

FIG. 10 is a plan view illustrating a modification example of a cutoff portion.

FIG. 11 is a plan view illustrating another modification example of a cutoff portion.

### DETAILED DESCRIPTION OF THE INVENTION

The following describes embodiments of the disclosure based on the drawings.

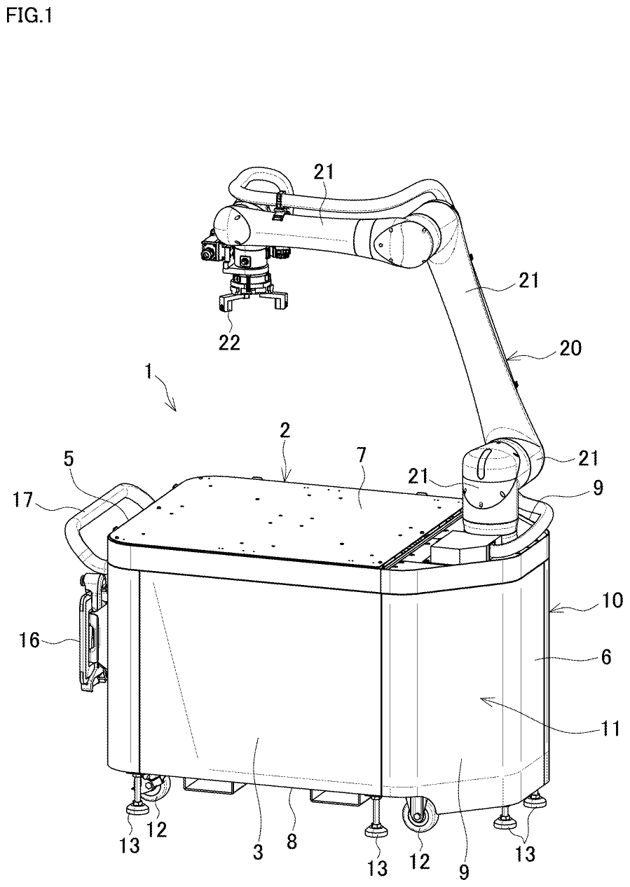

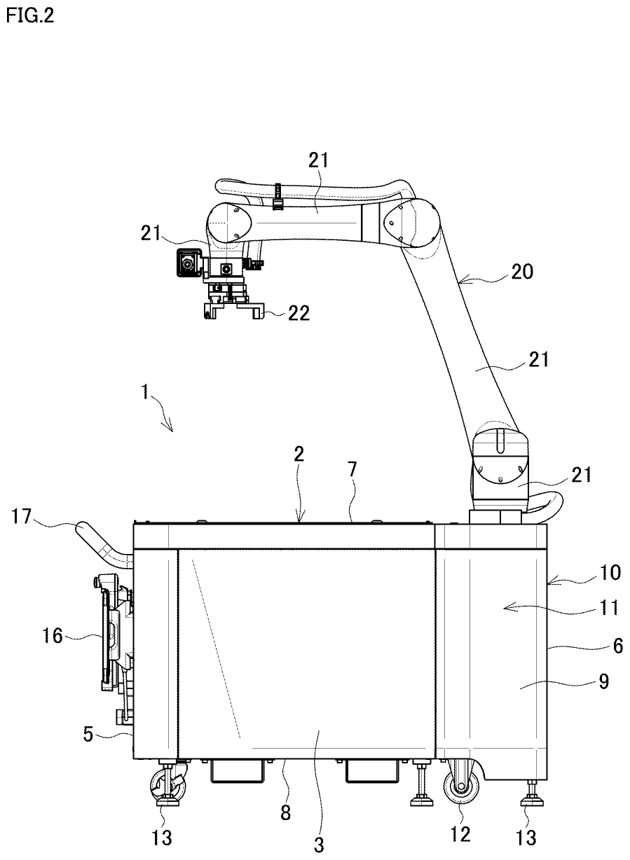

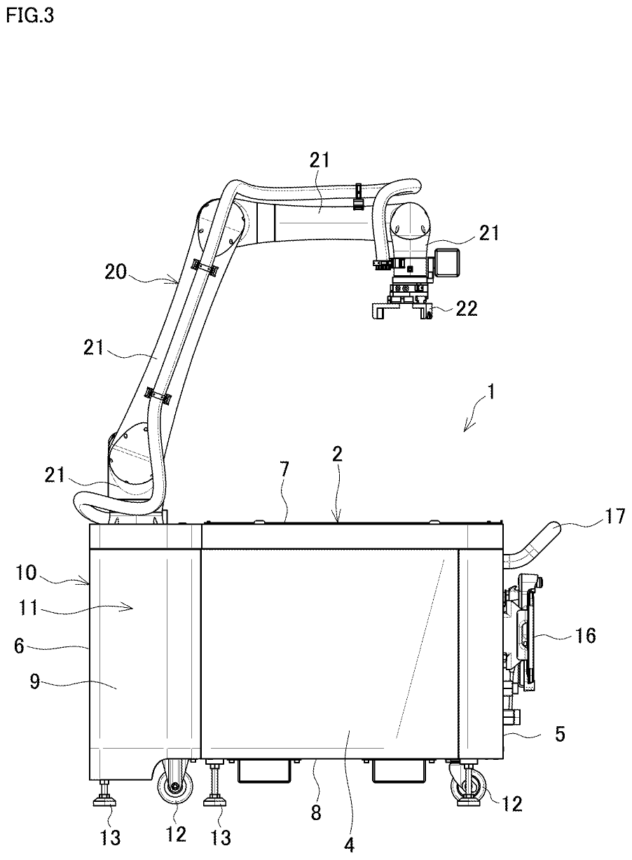

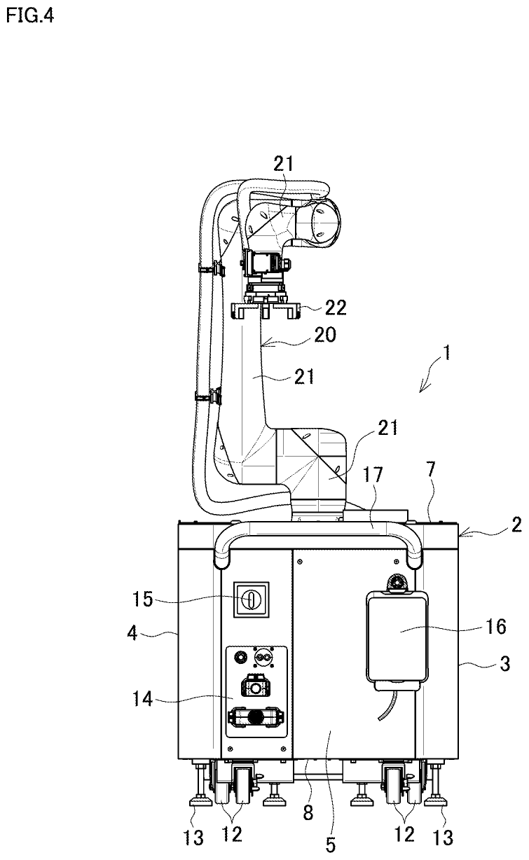

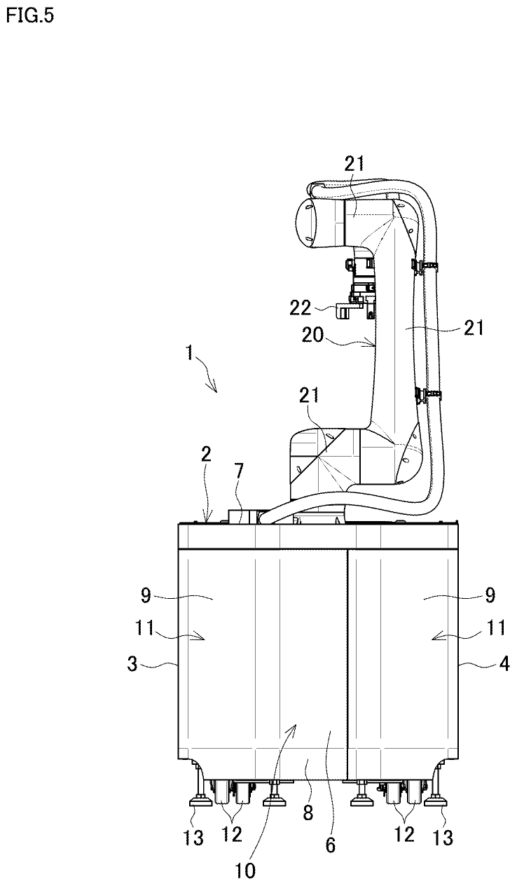

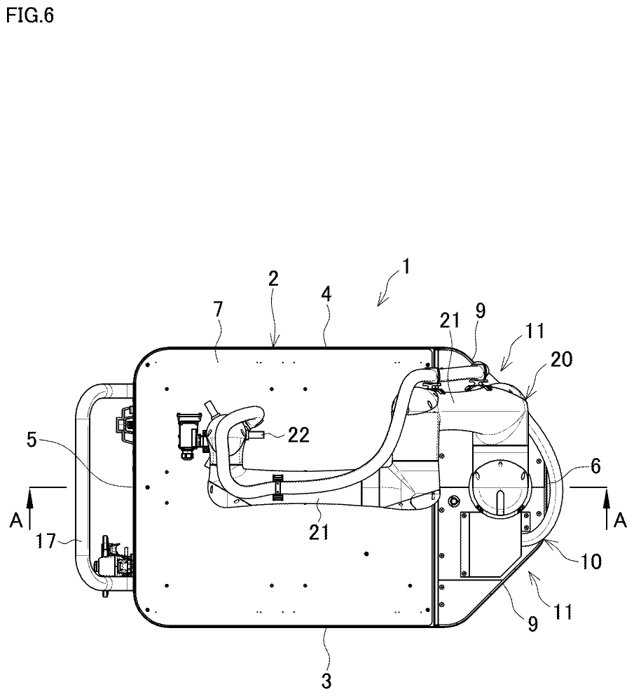

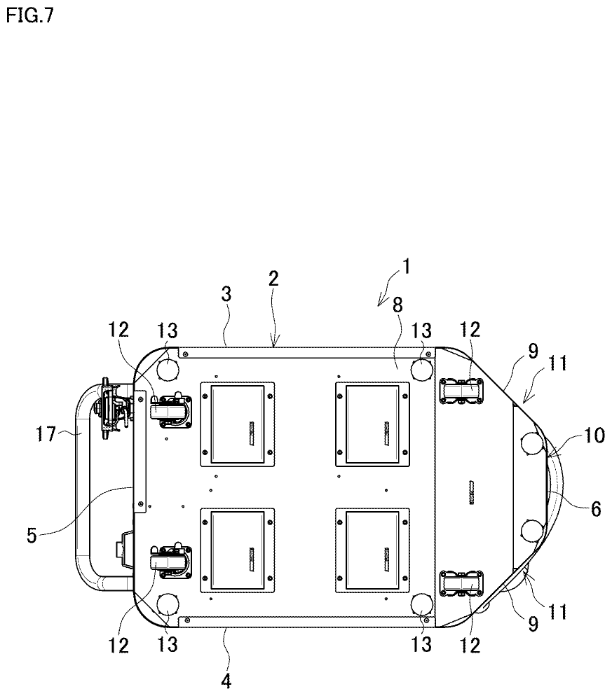

FIG. 1 is a perspective view illustrating one example of a robot mounting base, FIG. 2 is a front view, FIG. 3 is a back view, FIG. 4 is a left side view, FIG. 5 is a right side view, FIG. 6 is a plan view, and FIG. 7 is a bottom view.

A robot mounting base 1 includes a mounting base main body 2. The mounting base main body 2 has a box shape surrounded by a front surface portion 3, a rear surface portion 4, a left side surface portion 5, a right side surface portion 6, a top surface portion 7, and a bottom surface portion 8. On a left side of the mounting base main body 2, the front surface portion 3 and the rear surface portion 4 are formed in parallel. On a right side of the mounting base main body 2, the front surface portion 3 and the rear surface portion 4 form flat inclined surfaces 9, 9 that approach one another toward the right side, and are connected to the right side surface portion 6, a front-rear width of which is smaller than that of the left side surface portion 5. By the inclined surfaces 9, 9, a right end portion 10 of the mounting base main body 2 has a trapezoidal shape in a plan view with cutoff portions 11, 11 formed in the front and rear.

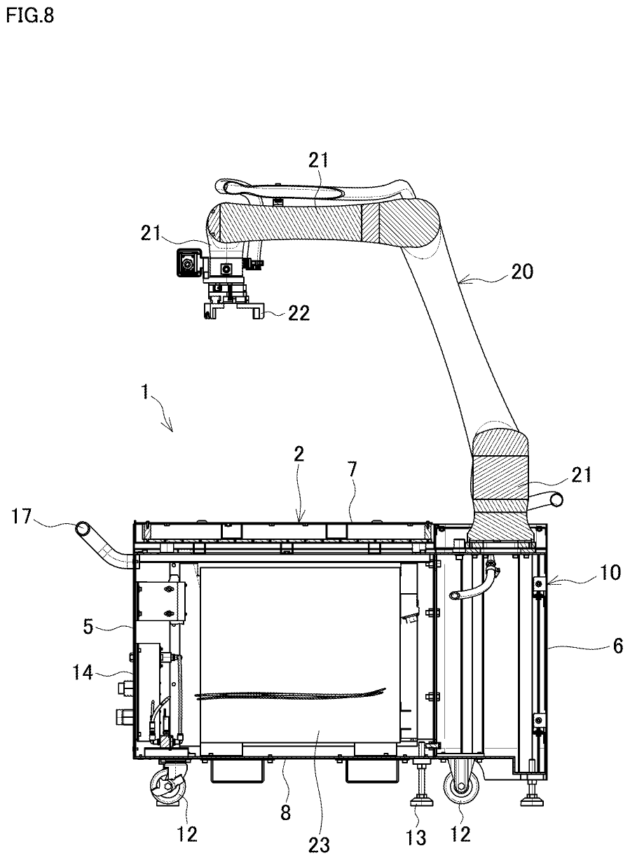

An articulated robot 20 is installed on the top surface portion 7 of the right end portion 10. The articulated robot 20 is constituted by connecting a plurality of arms 21, 21 . . . each driven by a motor (not illustrated), and a hand 22 is disposed at a distal end. As illustrated in FIG. 8, inside the mounting base main body 2, a control device 23 for the articulated robot 20 is disposed.

A plurality of casters 12, 12 . . . and a plurality of floor stoppers 13, 13 . . . are disposed on the bottom surface portion 8 of the mounting base main body 2.

As illustrated in FIG. 4, a connecting portion 14 for a power supply cable and the like, a switch 15, and an operation display 16 are disposed on the left side surface portion 5 of the mounting base main body 2. A handle 17 extending in the front-rear direction is disposed on an upper portion of the left side surface portion 5.

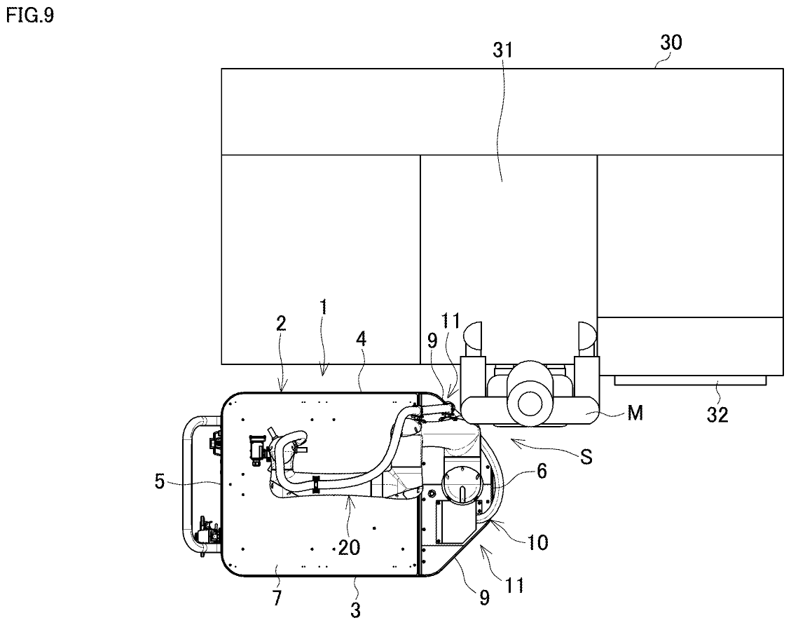

As illustrated in FIG. 9, the robot mounting base 1 configured as described above is installed laterally on a front surface side of a machine tool 30 with the right end portion 10 directed to the right side and the rear surface portion 4 parallel to and close to the front surface of the machine tool 30. In the installation state, since the right end portion 10 is positioned in front of a working chamber 31, the articulated robot 20 can take a workpiece in and out of the working chamber 31 the door of which is opened.

At this time, an operator M sometimes operates a control panel 32, performs maintenance in the working chamber 31, or the like on the front surface side of the machine tool 30 with the robot mounting base 1 installed. Here, the right end portion 10 having a trapezoidal shape in a plan view creates a wide space S including the cutoff portion 11 between the robot mounting base 1 and the machine tool 30. Accordingly, the operator M can work without being hindered by the robot mounting base 1.

Thus, the robot mounting base 1 of the above-described configuration includes the articulated robot 20 as one example of an industrial robot on the top surface portion 7 as one example of a top surface of the mounting base main body 2. The robot mounting base 1 allows the articulated robot 20 to work with respect to the machine tool 30 in the installation state close to the front surface as one example of an outer surface of the machine tool 30.

Furthermore, in the installation state, the cutoff portion 11 is formed at the right end portion 10 as one example of one end portion in a right-left direction as one example of a horizontal direction along the front surface of the machine tool 30 in the mounting base main body 2. The cutoff portion 11 positions so that the rear surface portion 4 as one example of a surface on the machine tool 30 side is away from the machine tool 30 with respect to a left end portion as one example of another end portion.

According to the configuration, the wide space S including the cutoff portion 11 is formed between the mounting base main body 2 and the machine tool 30 even when the mounting base main body 2 is installed close to the machine tool 30. Accordingly, the work by the operator is no longer hindered.

The cutoff portion 11 is formed by making the rear surface portion 4 into the inclined surface 9 that inclines in a direction away from the machine tool 30 toward the right end portion 10 side.

Accordingly, the cutoff portion 11 can be easily formed.

The inclined surface 9 is partially formed on the right end portion 10 side, and the articulated robot 20 is installed on the top surface of the right end portion 10.

Accordingly, it is possible to ensure the wider space S for the operator M to work by suppressing an amount of the mounting base main body 2 projecting to a working position of the articulated robot 20 on the front surface side of the machine tool 30.

A pair of inclined surfaces 9 are disposed so as to be symmetrical in a plan view with the installation position of the articulated robot 20 as a center, and the right end portion 10 has a trapezoidal shape as one example of a tapered shape in a plan view.

Accordingly, the space S can be similarly formed even when the mounting base main body 2 is installed in a left-right reverse direction.

While, in the above-described configuration, the inclined surface forming the cutoff portion is shaped flat, the inclined surface may be a depressed curved surface or a protruding curved surface. The tapered shape of the right end portion may be a triangular shape or the like instead of a trapezoidal shape.

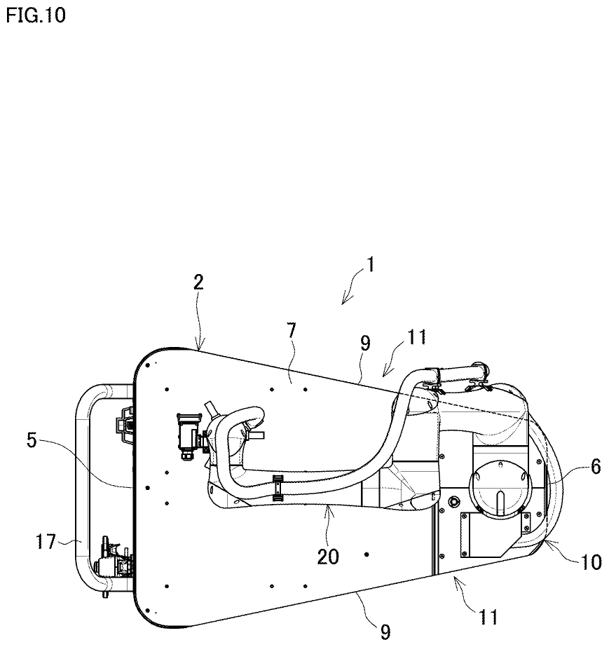

While, in the above-described configuration, the inclined surfaces are formed on a part of the front and rear surfaces of the mounting base main body, as illustrated in FIG. 10, the cutoff portions 11, 11 may be formed by forming the inclined surfaces 9, 9 over the entire front and rear surfaces of the mounting base main body 2. That is, the entire planar view of the mounting base main body 2 may be a trapezoidal shape or a triangular shape tapering toward the right end portion 10.

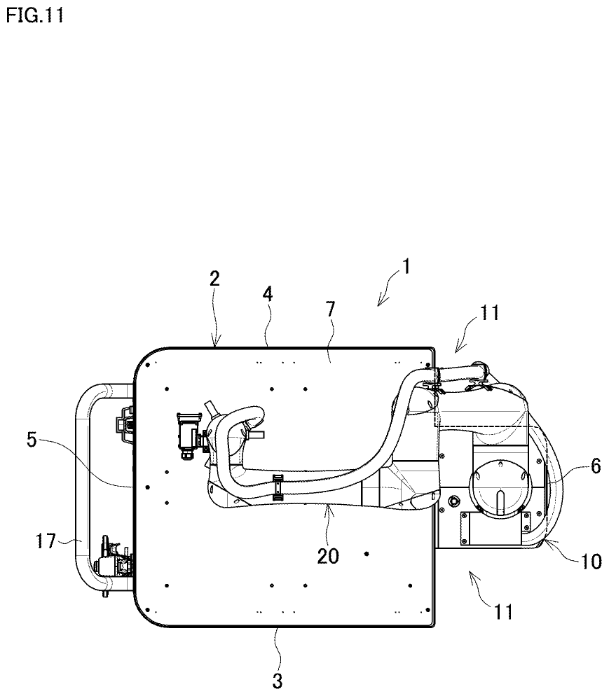

The cutoff portion is not limited to the formation by the inclined surface as the above-described configuration. For example, as illustrated in FIG. 11, the cutoff portions 11, 11 may be formed by recessing the right end portion sides of the front surface portion 3 and the rear surface portion 4 toward the center side in the front-rear direction in a stepped shape to cause the right end portion 10 to have a protruding shape.

The end portion where the cutoff portions are disposed may be the left end portion.

The cutoff portion is not limited to the configuration formed on both the front and rear surfaces of the mounting base main body as the above-described configuration and may be formed only on any one of the front and rear surfaces.

While, in the above-described configuration, the cutoff portions are formed only at one end portion of the mounting base main body, they may be formed at both end portions.

A caster with a stopper may be disposed instead of the floor stopper on the bottom surface portion. The mounting base main body may be self-propellable by disposing driving wheels driven by a motor or the like.

The number of arms, the shape of the hand, and the like of the articulated robot are not limited to the above-described configuration. Another industrial robot may be installed. The installation position can also be appropriately changed.

The shape of the machine tool is also not limited to the above-described configuration. The outer surface of the machine tool to which the robot mounting base is brought close is not limited to the front surface.

It is explicitly stated that all features disclosed in the description and/or the claims are intended to be disclosed separately and independently from each other for the purpose of original disclosure as well as for the purpose of restricting the claimed invention independent of the composition of the features in the embodiments and/or the claims. It is explicitly stated that all value ranges or indications of groups of entities disclose every possible intermediate value or intermediate entity for the purpose of original disclosure as well as for the purpose of restricting the claimed invention, in particular as limits of value ranges.

1. A robot mounting base for an industrial robot, comprising
a mounting base main body having a top surface on which the industrial robot is disposed, wherein
the robot mounting base allows the industrial robot to work on a machine tool in an installation state close to an outer surface of the machine tool, and
a cutoff portion is formed at least at one end portion in the mounting base main body in a horizontal direction along the outer surface in the installation state, and the cutoff portion positions so that a surface on the machine tool side is away from the machine tool with respect to another end portion.

2. The robot mounting base according to claim 1, wherein
the cutoff portion is formed by making the surface on the machine tool side into an inclined surface that inclines in a direction away from the machine tool toward the one end portion side.

3. The robot mounting base according to claim 2, wherein
the inclined surface is partially formed on the one end portion side, and
the industrial robot is installed on a top surface of the one end portion.

4. The robot mounting base according to claim 3, wherein
a pair of inclined surfaces are disposed so as to be symmetrical in a plan view with an installation position of the industrial robot as a center, and the one end portion has a tapered shape.
